(19) United States
(12) Patent Application Publication
(10) Pub. No.: US 2010/0132527 A1
(43) Pub. Date: Jun. 3, 2010

(54) Saw blade adjustment structure for table saw

(75) Inventors: Chia-Sheng Liu, Taichung County (TW); Chieh-Yuan Tsai, Taichung County (TW)

Correspondence Address: BACON & THOMAS, PLLC, 625 SLATERS LANE, FOURTH FLOOR, ALEXANDRIA, VA, 22314-1176, US

(73) Assignee: DURQ MACHINERY CORP., Taichung (TW)

(21) Appl. No.: 12/320,230

(22) Filed: Jan. 22, 2009

(30) Foreign Application Priority Data
Dec. 2, 2008 (TW) 97146842

(51) Int. Cl. B27B 5/00

(52) U.S. Cl. 83/477.1

(57) ABSTRACT

A saw blade adjustment structure for table comprises a support rod inserted through a respective arched sliding slot on a front support panel and a rear support panel, a handle pivoted to the front end of the support rod and biasable between a holding down position and a release position, and an adjustment member set between the front support panel and the handle and having an oblong hole coupled to the support rod such that the adjustment member is movable between an initial position and a push-out position subject to movement of the handle between the holding down position and the release position.

### BACKGROUND OF THE INVENTION

1. Field of the Invention

The present invention relates to a table saw and more particularly, to a saw blade adjustment structure for table saw.

2. Description of the Related Art

The adjustment of the saw blade of a table saw includes two items, i.e., elevation and tilt angle. Controlling the tilt angle of a table saw's saw blade is for enabling a user to cut a sloping plane on the workpiece. According to a regular saw blade adjustment structure, a user must rotate a camshaft handle to stop the cam of the camshaft hand tightly against a side plate of the table saw after adjustment of the tilt angle of the saw blade, locking the saw blade in the adjusted tilt position. However, the camshaft handle tends may be moved accidentally by an external force to unlock the saw blade, keeping the saw blade in an unstable status of use. Further, when rotating the camshaft handle to force the cam against the side plate of the table saw, the eccentric axis of the camshaft handle will be deviated slightly, causing a minor displacement of the saw blade. This minor displacement may be not observable by the eyes, however it is harmful to cutting accuracy.

Therefore, it is desirable to provide a saw blade adjustment structure for table saw that eliminates the aforesaid problem.

### SUMMARY OF THE INVENTION

The present invention has been accomplished under the circumstances in view. It is one object of the present invention to provide a saw blade adjustment structure for table saw, which avoids deviation of the saw blade after locking, assuring a very high degree of cutting accuracy.

To achieve this and other objects of the present invention, a saw blade adjustment structure for table comprises a holder base, a support rod, a handle, and an adjustment member. The holder base comprises a front support panel and a rear support panel. The front support panel comprises an arched sliding slot. The rear support panel comprises an arched support slot. The support rod comprises a front end inserted through the arched sliding slot of the front support panel, and a rear end inserted through the arched sliding rod of the rear support panel. The handle is pivoted to the front end of the support rod, and biasable between a holding down position and a release position. The adjustment member is set between the front support panel of the holder base and the handle, comprising an oblong hole coupled to the support rod such that the adjustment member is movable between an initial position and a push-out position subject to movement of the handle between the holding down position and the release position.

### BRIEF DESCRIPTION OF THE DRAWINGS

FIG. 1 is a perspective view of a saw blade adjustment structure in accordance with the present invention.

FIG. 2 corresponds to FIG. 1 when viewed from another angle.

FIG. 3 is a side view of the saw blade adjustment structure in accordance with the present invention.

FIG. 4 is an exploded view of a part of the saw blade adjustment structure in accordance with the present invention.

FIG. 5 is a perspective view of the handle of the saw blade adjustment structure according to the present invention.

FIG. 6 is a schematic drawing of the present invention, showing the handle in the release position.

FIG. 7 is a similar to FIG. 6 but showing the handle in the holding down position.

FIG. 8 is similar to FIG. 6, showing the handle biased through a relatively greater angle.

### DETAILED DESCRIPTION OF THE INVENTION

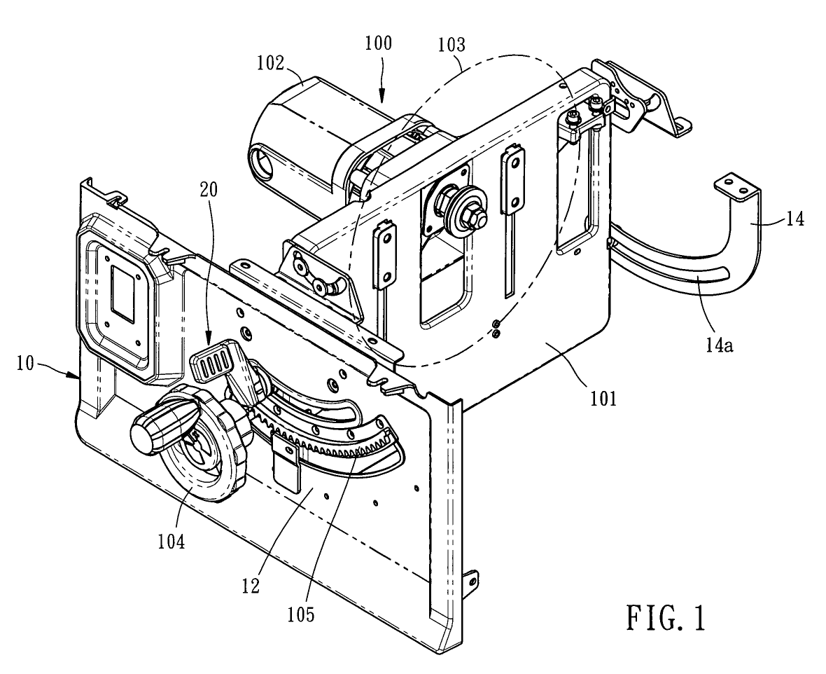

Referring to FIGS. 1˜3, a saw blade adjustment structure in accordance with the present invention comprises a holder base 10, a support rod 16, a adjustment member 18, a handle 20, and a pin 22.

The holder base 10 includes a front support panel 12 and a rear support panel 14 respectively made of a metal material. The front support panel 12 and the rear support panel 14 are kept apart from each other at a distance. The front support panel 12 has an arched sliding slot 12a. The rear support panel 14 has an arched sliding slot 14a.

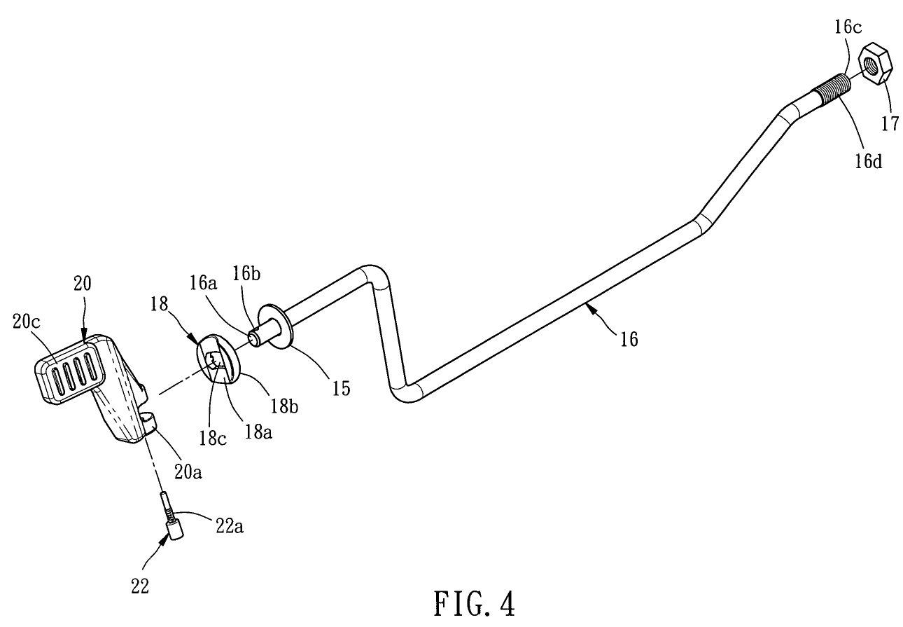

Referring also to FIG. 4, the support rod 16 is a curved round rod having two straight ends. One end, namely, the front end 16a of the support rod 16 is inserted through the arched sliding slot 12a of the front support panel 12 and a washer, having a transverse screw hole 16b. The other end, namely, the rear end 16c of the support rod 16 is inserted through the arched sliding slot 14a of the rear support panel 14, having an outer thread 16d for the mounting of a nut 17.

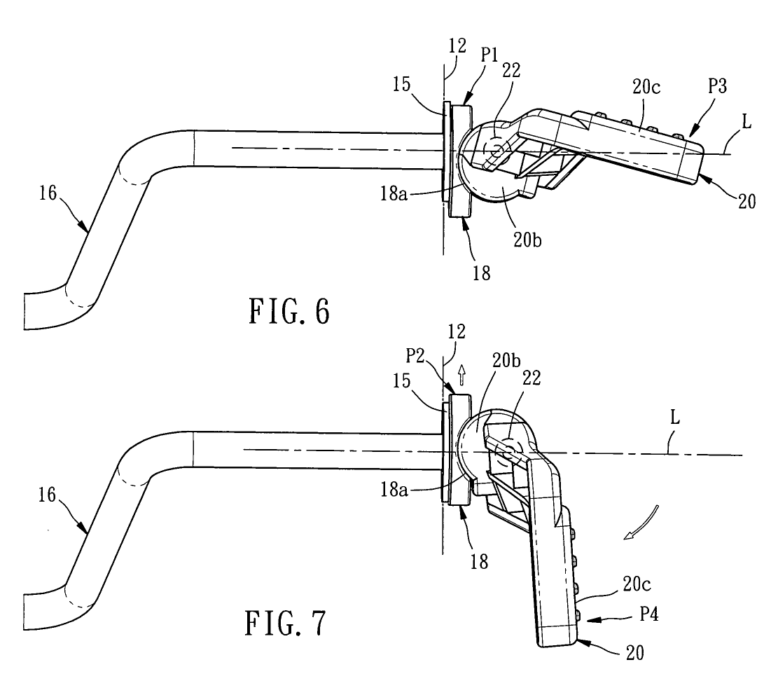

The adjustment member 18 is a circular pad made of, but not limited to, rubber. The adjustment member 18 has a concave surface 18a, a flat surface 18b, and an oblong hole 18c cut through the concave surface 18a. The flat surface 18b faces the front support panel 12. The oblong hole 18c is coupled to the support rod 16. After installation, the adjustment member 18 is disposed at an outer side relative to the front support panel 12. Because the length of the major axis of the oblong hole 18c is greater than the diameter of the support rod 16, the adjustment member 18 can be biased relative to the support rod 16 between an initial position P1 (see FIG. 6) and a push-out position P2 (see FIG. 7).

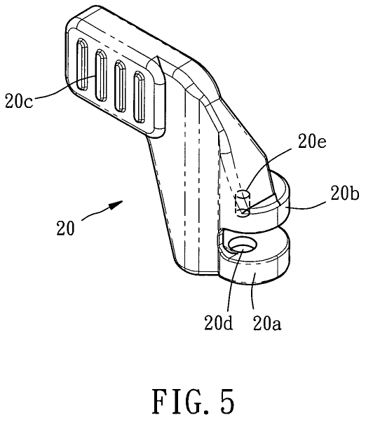

Referring also to FIG. 5, the handle 20 comprises two protruding blocks 20a and 20b arranged in parallel and kept away from each other at a distance, a grip 20c connected with the protruding blocks 20a and 20b, an eccentric hole 20d cut through one protruding block 20a, and a countersunk hole 20e formed in the other protruding block 20b in alignment with the eccentric hole 20d.

The front end 16a of the support rod 16 is inserted through the oblong hole 18c of the adjustment member 18 into the space between the two protruding blocks 20a and 20b. The pin 22 has a threaded shank 22a. The pin 22 is inserted through the eccentric hole 20d to thread the threaded shank 22a into the transverse screw hole 16b of the support rod 16 and to engage its distal end into the countersunk hole 20e. Further, the protruding blocks 20a and 20b of the handle 20 have the respective front edges curved smoothly outwards, fitting the concave surface 18a of the adjustment member 18. After installation, the handle 20 is pivotally connected to the front end 16a of the support rod 16, and biasable relative to the support rod 16 between a release position P3 (see FIG. 6) and a holding down position (see FIG. 7).

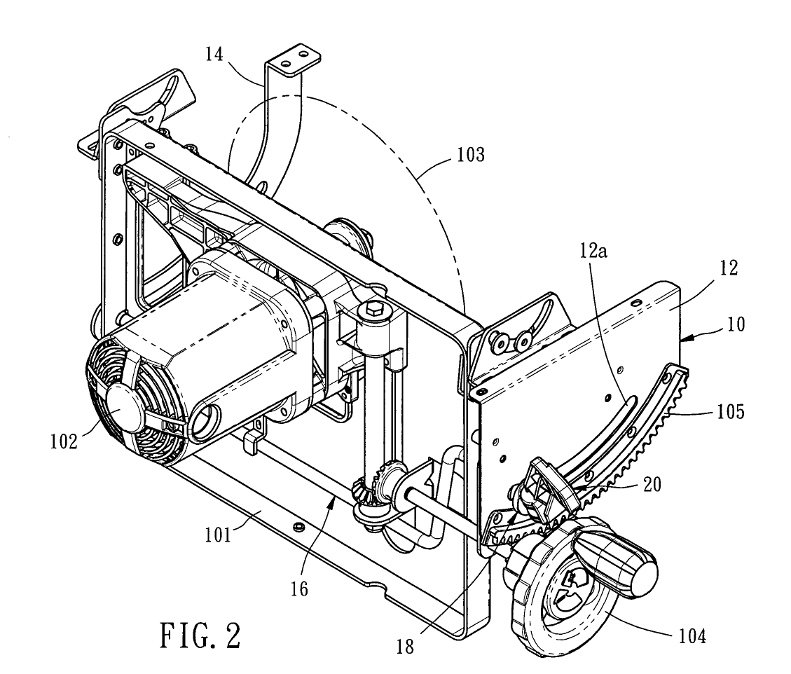

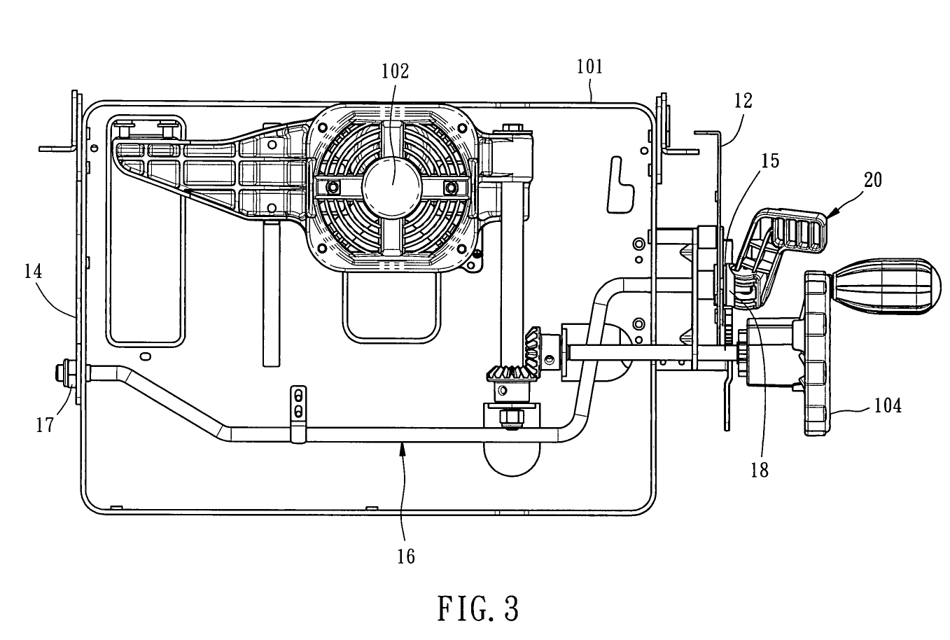

After installation of the saw blade adjustment structure in a table saw 100, the relationship between the saw blade adjustment structure and the saw blade 103 is shown in FIG. 2 where the support rod 16 is joined to a bracket 101 of the table saw 100. The bracket 101 supports the motor 102 and saw blade 103 of the table saw 100. When the handle 20 is in the release position P3 (see FIG. 6), the grip 20c of the handle 20 is kept perpendicular to the front support panel 12, a user can operate a hand wheel 104 to rotate a rack 105, adjusting the tilt angle of the saw blade 103. At the same time, the support rod 16 is relatively moved along the arched sliding slot 12a of the front support panel 12 and the arched sliding slot 14a of the rear support panel 14.

After adjustment of the saw blade 103 to the desired tilt angle, turn the handle 20 about the pin 22, as shown in FIG. 7, to move the grip 20c toward the front support panel 12, causing the adjustment member 1 to be pushed by the protruding blocks 20a and 20b of the handle 20 from the initial position P1 shown in FIG. 6 to the push-out position P2 shown in FIG. 7. At this time, the pin 22 is moved along the extension line L of the support rod 16 in direction away from the front support panel 12. Movement of the pin 22 in this direction causes the support rod 16 to be pulled, forcing the nut 17 at the rear end 16c of the support rod 16 against the rear support panel 14 more tightly, and therefore the saw blade 103 is locked firmly in the adjusted tilt angle. Further, after position change, the pin 22 is still kept in the extension line L of the support rod 16, i.e., no any displacement occurs on the bracket 101 of the table saw 100. Therefore, the saw blade 103 is kept in position, assuring a very high degree of cutting accuracy.

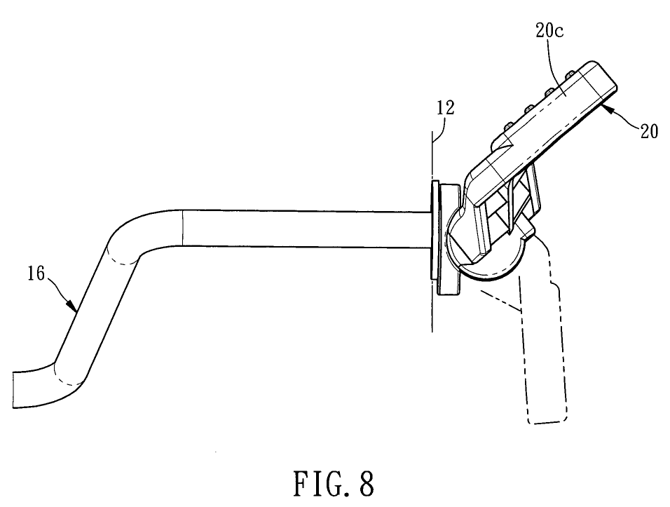

Under the status shown in FIG. 6, the grip 20c of the handle 20 is kept perpendicular to the front support panel 12 and may interfere with the operation of the hand wheel 104. To avoid this problem, the invention allows a user to bias the handle 20 through a relatively greater angle without affecting the function of the handle 20 (see FIG. 8). The contained angle between the extending direction of the grip 20c shown in FIG. 8 and the extending direction of the grip 20c shown in FIG. 6 (see the imaginary line) is about 210-degrees. Thus, the handle 20 will never hinder the operation of the hand wheel 104.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A saw blade adjustment structure, comprising:
a holder base, said holder base comprising a front support panel and a rear support panel, said front support panel comprising an arched sliding slot, said rear support panel comprising an arched support slot;
a support rod, said support rod comprising a front end inserted through the arched sliding slot of said front support panel, and a rear end inserted through the arched sliding rod of said rear support panel;
a handle pivoted to the front end of said support rod and biasable between a holding down position and a release position; and
an adjustment member set between said front support panel of said holder base and said handle, said adjustment member having an oblong hole through which said support rod passes such that said adjustment member is movable between an initial position and a push-out position subject to movement of said handle between said holding down position and said release position.

2. The saw blade adjustment structure as claimed in claim 1, wherein said handle comprises a first protruding block, a second protruding block spaced from said first protruding block at a predetermined distance, a grip connected with said first protruding block and said second protruding block, an eccentric hole cut through at least one of said first protruding block and said second protruding block; said support rod comprises a transverse through hole cut through the front end thereof and kept in axial alignment with said eccentric hole and connected to said first protruding block and said second protruding block by a pin that is inserted into said eccentric hole and said transverse through hole.

3. The saw blade adjustment structure as claimed in claim 2, wherein said first protruding block and said second protruding block each have smoothly outwardly curved front edge; said adjustment member comprises a concave surface matching the smoothly outwardly curved front edges of said first protruding block and said second protruding block.

4. The saw blade adjustment structure as claimed in claim 2, wherein said transverse through hole of said support rod is a screw hole; said pin comprises a threaded shank threaded into said screw hole.

5. The saw blade adjustment structure as claimed in claim 1, wherein the rear end of said support rod comprises an outer thread screwed up with a nut.
